(19) United States
(12) Patent Application Publication
(10) Pub. No.: US 2024/0370712 A1
(43) Pub. Date: Nov. 7, 2024

(54) COMPUTING DEVICE, NEURAL NETWORK SYSTEM, NEURON MODEL DEVICE, COMPUTING METHOD, AND PROGRAM

(71) Applicant: NEC Corporation, Minato-ku, Tokyo (JP)

(72) Inventors: Yusuke SAKEMI, Tokyo (JP); Takeo HOSOMI, Tokyo (JP)

(73) Assignee: NEC Corporation, Minato-ku, Tokyo (JP)

(21) Appl. No.: 18/292,968

(22) PCT Filed: Aug. 6, 2021
(86) PCT No.: PCT/JP2021/029277

§ 371 Date: Jan. 29, 2024

(51) Int. Cl. G06N 3/049; G06F 17/13; G06N 3/08

(52) U.S. Cl. CPC G06N 3/049; G06F 17/13; G06N 3/08

(57) ABSTRACT

A computing device includes: a neuron model in which an input time interval for receiving a spike and an output time interval for firing and a transmitting spike are divided, wherein the neuron model fires within the output time interval, with firing within the input time interval being restricted.

### TECHNICAL FIELD

The present invention relates to a computing device, a neural network system, a neuron model device, a computing method, and a program.

### BACKGROUND ART

One type of neural network is an SNN (Spiking Neural Network). For example, Patent Document 1 discloses a neuromorphic computing system in which a spiking neural network is implemented on a neuromorphic computing device.

In a spiking neural network, a neuron model has an internal state called a membrane potential, and outputs signals called spikes based on the temporal evolution of the membrane potential.

### PRIOR ART DOCUMENTS

### Patent Documents

Patent Document 1: Japanese Unexamined Patent Application, First Publication No. 2018-136919

### SUMMARY OF THE INVENTION

### Problems to be Solved by the Invention

It is preferable that a spiking neural network be able to process data efficiently.

An example object of the present invention is to provide a computing device, a neural network system, a neuron model device, a computing method, and a program, capable of solving the above problem.

### Means for Solving the Problem

According to a first example aspect of the present invention, a computing device includes: a neuron model in which an input time interval for receiving a spike and an output time interval for firing and a transmitting spike are divided, wherein the neuron model fires within the output time interval, with firing within the input time interval being restricted.

According to a second example aspect of the present invention, a neural network system includes a neural network main body, and a learning means, wherein an input time interval for receiving a signal and an output time interval in which signal transmission is permitted are divided in association with firing, an input and output time in which reception and transmission of a signals are permitted is set in association with firing of some of layers among a plurality of layers constituting the neural network main body, and the neural network main body includes a neuron model including an index value calculation means that changes an index value of signal output based on an input status of a signal within an input time interval, and a signal output means that outputs a signal within an output time interval after end of the input time interval, based on the index value, and the learning means performs learning of a weight coefficient for the signal.

According to a third example aspect of the present invention, an input time interval for receiving a spike and an output time interval in which spike transmission is permitted are divided in association with forcible firing, the neuron model device includes: an index value calculation unit that changes an index value of signal output based on an input status of a signal within the input time interval; and a signal output unit that transmits a spike within the output time interval by firing based on the index value of the signal output.

According to a fourth example aspect of the present invention, a computing method includes: identifying an input time interval for receiving a spike and an output time interval in which spike transmission is permitted that are divided in association with forcible firing; changing an index value of signal output based on an input status of a signal within the input time interval; and transmitting a spike within the output time interval by firing based on the index value of the signal output.

According to a fourth example aspect of the present invention, a program causes a program-executing device to execute: identifying an input time interval for receiving a spike and an output time interval in which spike transmission is permitted that are divided in association with forcible firing; changing an index value of signal output based on an input status of a signal within the input time interval; and transmitting a spike within the output time interval by firing based on the index value of the signal output.

### Effect of Invention

According to the present invention, a spiking neural network is able to process data efficiently.

### BRIEF DESCRIPTION OF THE DRAWINGS

FIG. 1 is a diagram showing a configuration example of a neural network device according to a first example embodiment.

FIG. 2 is a diagram showing a configuration example of a spiking neural network included in the neural network device according to the example embodiment.

FIG. 3 is a diagram showing an example of temporal changes in membrane potential in a spiking neuron model according to the example embodiment in which the output timing of spike signals is not restricted.

FIG. 4 is a diagram showing an example of the output timing of spike signals of the spiking neuron model in the spiking neural network in the case where the output timing of the spike signal of the spiking neuron model according to the example embodiment is not restricted.

FIG. 5A is a diagram showing an example of timings of passing spike signals between neuron models in the neural network device according to the example embodiment.

FIG. 5B is a diagram showing an example of timings of passing spike signals between neuron models in the neural network device according to the example embodiment.

FIG. 6 is a diagram showing an example of setting time intervals according to the example embodiment.

FIG. 7 is a diagram showing a first example of a clip function according to the example embodiment.

FIG. 8 is a diagram showing a second example of the clip function according to the example embodiment.

FIG. 9 is a diagram showing an example of a system configuration at the time of performing learning in the example embodiment.

FIG. 10 is a diagram showing an example of signal input/output in a neural network system 1 according to the example embodiment.

FIG. 11 is a diagram showing an example of signal input/output in the neural network device at the time of operating in the example embodiment.

FIG. 12 is a diagram showing an example of threshold value reaching times at the time of performing learning in the example embodiment.

FIG. 13 is a diagram showing an example of firing times at the time of performing learning in the example embodiment.

FIG. 14 is a diagram showing an example of threshold value reaching times at the time of testing in the example embodiment.

FIG. 15 is a diagram showing an example of firing times at the time of testing in the example embodiment.

FIG. 16 is a diagram showing a configuration example of the neural network device according to the example embodiment.

FIG. 17 is a diagram showing a configuration example of a neuron model device according to the example embodiment.

FIG. 18 is a diagram showing a configuration example of the neural network system according to the example embodiment.

FIG. 19 is a flowchart showing an example of a processing procedure in a computing method according to the example embodiment.

FIG. 20 is a schematic block diagram showing a configuration of a computer according to at least one of the example embodiments.

FIG. 21 is a diagram showing a configuration example of a neural network device according to a second example embodiment.

FIG. 22 is a diagram for describing the results of identification processing according to the second example embodiment.

FIG. 23 is a diagram for describing the output results of a first convolutional layer and a first pooling layer according to the second example embodiment.

FIG. 24 is a diagram for describing the output results of a second convolutional layer and a second pooling layer according to the second example embodiment.

### Example Embodiment

Hereinafter, example embodiments of the present invention will be described, however, the present invention within the scope of the claims is not limited by the following example embodiments. Furthermore, not all the combinations of features described in the example embodiments are essential for the solving means of the invention.

### First Example Embodiment

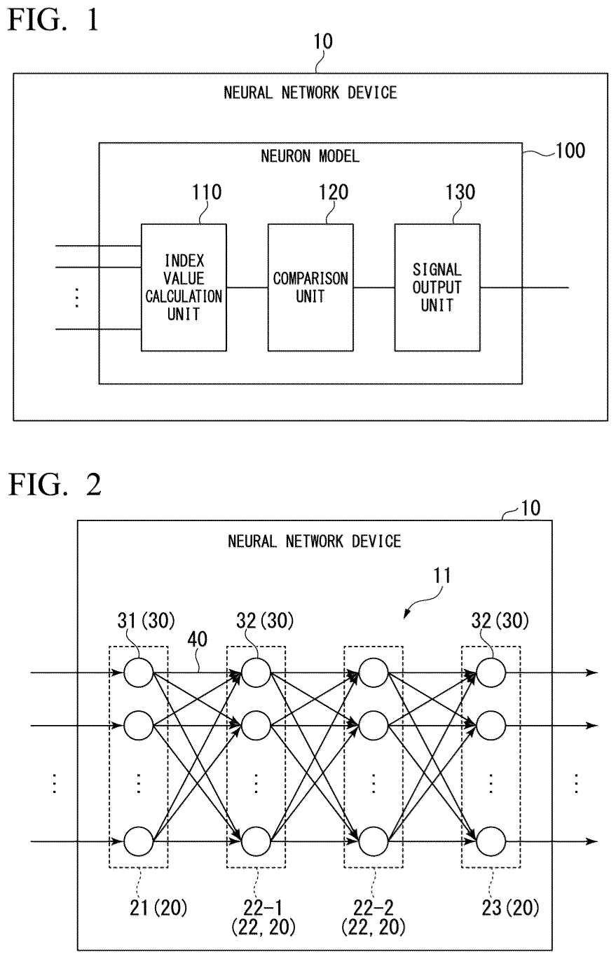

FIG. 1 is a diagram showing a configuration example of a neural network device according to an example embodiment. With the configuration shown in FIG. 1, a neural network device 10 (computing device) includes a neuron model 100. The neuron model 100 includes an index value calculation unit 110, a comparison unit 120, and a signal output unit 130.

The neural network device 10 performs data processing, using a spiking neural network. The neural network device 10 corresponds to an example of the computing device.

The neural network device referred to here is a device in which a neural network is implemented. A spiking neural network may be implemented in the neural network device 10 using dedicated hardware. For example, a spiking neural network may be implemented in the neural network device 10, using an ASIC (Application Specific Integrated Circuit) or an FPGA (Field Programmable Gate Array). Alternatively, a spiking neural network may be implemented in the neural network device 10 in software, using a computer or the like.

A device including an ASIC, a device including an FPGA, and a computer are all examples of a programmable device. In ASIC and FPGA, an example of programming is to describe hardware using a hardware description language and implement the described hardware on an ASIC or an FPGA. In the case where the neural network device 10 is configured using a computer, the functions of the spiking neural network may be described by programming, and the resulting program may be executed by the computer.

The spiking neural network referred to here is a neural network in which a neuron model outputs a signal at a timing based on a state amount called membrane potential, which undergoes temporal changes depending on the input status of the signal to the neuron model itself. The membrane potential is also referred to as an index value of signal output, or simply as an index value.

The temporal changes here means that the changes occur depending on time.

A neuron model in a spiking neural network is also referred to as a spiking neuron model. A signal output by a spiking neuron model is also referred to as a spike signal or a spike. In a spiking neural network, a binary signal can be used as a spike signal, and information can be transmitted between spiking neuron models by the transmission timing of spike signals or the number of spike signals.

In the case of the neuron model 100, the index value calculation unit 110 calculates the membrane potential based on the status of spike signal input to the neuron model 100. The signal output unit 130 outputs a spike signal at a timing that corresponds to a temporal change in membrane potential.

The spike signal in the neural network device 10 may be a pulse signal or a step signal, however, the invention is not limited to these examples.

In the following, a case will be described using as an example a temporal method in which information is transmitted at the transmission timing of a spike signal, as a method of transmitting information between neuron models 100 in the spiking neural network by the neural network device 10. However, the method of transmitting information between the neuron models 100 in the spiking neural network by the neural network device 10 is not limited to a specific method.

The processing performed by the neural network device 10 can be various processes that can be executed using a spiking neural network. For example, the neural network device 10 may perform image recognition, biometric authentication, or numerical value prediction, however the invention is not limited to these examples.

The neural network device 10 may be configured as one device, or may be configured as a combination of a plurality of devices. For example, each neuron model 100 may be configured as a device, and the devices constituting each neuron model 100 may be connected via a signal transmission path to form a spiking neural network.

FIG. 2 is a diagram showing a configuration example of the spiking neural network included in the neural network device 10. The spiking neural network included in the neural network device 10 is also represented as a neural network 11. Moreover, the neural network 11 is also referred to as a neural network main body.

In the example of FIG. 2, the neural network 11 is configured as a forward propagation four-layer spiking neural network. Specifically, the neural network 11 includes an input layer 21, two intermediate layers 22-1, 22-2, and an output layer 23. The two intermediate layers 22-1, 22-2 are also collectively referred to as intermediate layer 22. The intermediate layer is also called a hidden layer. The input layer 21, the intermediate layers 22, and the output layer 23 are also collectively referred to as layer 20.

The input layer 21 includes input nodes 31. The intermediate layer 22 includes intermediate nodes 32. The output layer 23 includes output nodes 33. The input nodes 31, the intermediate nodes 32, and the output nodes 33 are also collectively referred to as nodes 30.

the input node 31 converts input data to the neural network 11 into a spike signal, for example. Alternatively, in the case where the input data to the neural network 11 is represented by a spike signal, the neuron model 100 may be used as the input node 31.

The neuron model 100 may be used as both the intermediate node 32 and the output node 33. Moreover, the operation of the neuron model 100 may be different between the intermediate node 32 and the output node 33, such as at the output node 33, where constraint conditions on spike signal output timing, which will be described later, are more relaxed than at the intermediate node.

The four layers 20 of the neural network 11 are arranged in the order of the input layer 21, the intermediate layer 22-1, the intermediate layer 22-2, and the output layer 23 from the upstream side in signal transmission. The nodes 30 are connected between two adjacent layers 20 via transmission paths 40. The transmission paths 40 transmit spike signals from the node 30 of the layer 20 on the upstream side to the node 30 of the layer 20 on the downstream side.

However, when the neural network 11 is configured as a forward propagation type spiking neural network, the number of layers is not limited to four, but may be two or more. Moreover, the number of neuron models 100 included in each layer is not limited to a specific number, and it is sufficient that each layer includes one or more neuron models 100. Each layer may include the same number of neuron models 100, or each layer may include a different number of neuron models 100.

Also, the neural network 11 may be configured in a fully-connected manner, but the invention is not limited to this example. In the example of FIG. 2, all the neuron models 100 of the layer 20 on the former stage side and all the neuron models 100 of the layer 20 on the latter stage side in adjacent layers may be connected by the transmission paths 40, however, there may be some neuron models 100 that are not connected by the transmission paths 40.

In the following description, it is assumed that the delay time in the transmission of spike signals can be ignored, and the spike signal output time of the neuron model 100 on the spike signal output side is the same as the spike signal input time to the neuron model 100 on the spike signal input side. In the case where the delay time in the transmission of spike signals cannot be ignored, a time obtained by adding the delay time to the spike signal output time may be used as the spike signal input time.

The spiking neuron model outputs a spike signal at a timing when the membrane potential undergoing temporal changes reaches a threshold value. In a general spiking neural network where the output timing of spike signals is not restricted, then when there are multiple sets of processing target data, it is necessary to wait for an input of the next input data to the spiking neural network until the spiking neural network has received an input of input data and has output the computation result.

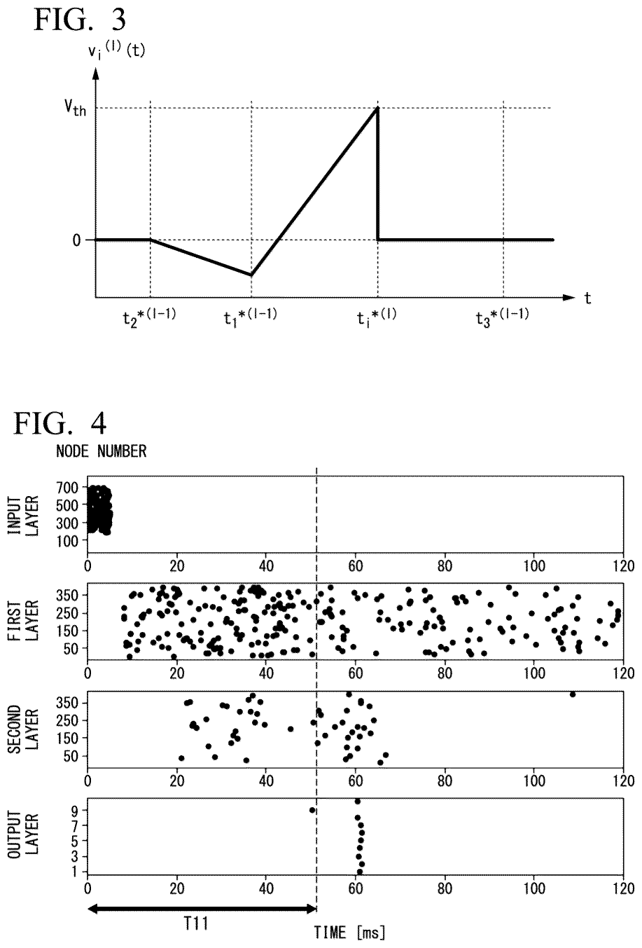

FIG. 3 is a diagram showing an example of temporal changes in membrane potential in a spiking neuron model in which the output timing of spike signals is not restricted. The horizontal axis of the graph in FIG. 3 represents time, and the vertical axis represents membrane potential.

FIG. 3 shows an example of the membrane potential of the spiking neuron model for the ith node of the lth layer. The membrane potential of the spiking neuron model of the ith node of the lth layer at time t is expressed as vᵢ^{(l)}(t). In the description of FIG. 3, the spiking neuron model for the ith node of the lth layer is also referred to as a target model. Time t indicates the elapsed time starting from the start time of a time interval assigned to the processing of the first layer.

In the example of FIG. 3, the target model receives input of spike signals from three spiking neuron models.

Time t₂*^{(l-1)} indicates the input time of the spike signal from the second spiking neuron model of the l−1th layer. Time t₁*^{(l-1)} indicates the input time of the spike signal from the first spiking neuron model of the l−1th layer. Time t₃*^{(l-1)} indicates the input time of the spike signal from the third spiking neuron model of the l−1th layer.

Furthermore, the target model outputs a spike signal at time tᵢ*^{(l)}. The output of a spike signal performed by the spiking neuron model is referred to as firing. The time when the spiking neuron model fires is referred to as firing time.

In the example of FIG. 3, the initial value of the membrane potential is set to 0. The initial value of membrane potential corresponds to the resting membrane potential.

Before the firing of the target model, after the input of the spike signal, the membrane potential vᵢ^{(l)}(t) of the target model continues to change at a rate of change (change speed) according to the weight set for each transmission path of the spike signal. Moreover, the rate of change in membrane potential for each spike signal input is added in a linear manner. The differential equation of the membrane potential vᵢ^{(l)} (t) in the example of FIG. 3 is expressed as Expression (1).

$$\begin{matrix}[ Expression 1 ] & \\ \frac{d}{dt} {v}_{i}^{( l )} ( t ) = {\sum }_{j} {w}_{ij}^{( l )} θ ( t - {t}_{j}^{* ( l - 1 )} ) & ( 1 )\end{matrix}$$

$$θ ( x ) = \{ \begin{matrix}0 , & ( x < 0 ) \\ 1 , & ( x \geq 0 )\end{matrix} \qquad ( 2 )$$

In Expression (1), wᵢⱼ^{(l)} represents the weight set in the transmission path of the spike signal from the jth spiking neuron model of the l−1th layer to the target model. The weight wᵢⱼ^{(l)} is a target of learning. The weight wᵢⱼ^{(l)} can take both positive and negative values.

θ is a step function and is expressed as in Expression (2). Therefore, the rate of change of the membrane potential vᵢ^{(l)} (t) changes while showing various values depending on the input status of the spike signal and the value of the weight wᵢⱼ^{(l)}, and in the process, it can take both positive and negative values.

For example, at time tᵢ*^{(l)} the membrane potential vᵢ^{(l)}(t) of the target model reaches the threshold Vₜₕ and the target model fires. The finring causes the membrane potential vᵢ^{(l)}(t) of the target model to become 0, and thereafter the membrane potential does not change even if the target model receives a spike signal input.

FIG. 4 is a diagram showing an example of the output timing of spike signals of the spiking neuron model in the spiking neural network in the case where the output timing of the spike signal of the spiking neuron model is not restricted.

The horizontal axis in FIG. 4 indicates time as elapsed time from the start of data input to the spiking neural network. The vertical axis indicates node numbers in each of the input layer, the first layer, the second layer, and the output layer. The node number for each layer is used as an identification number to identify the spiking neuron model within the layer.

In the example in FIG. 4, the spiking neuron model in the input layer fires within approximately 5 milliseconds from the start of data input to the spiking neural network. In contrast, the firing timing of the spiking neuron model of the first layer is scattered over a range of approximately 10 milliseconds to approximately 120 milliseconds of elapsed time from the start of data input to the spiking neural network. The firing timing of the spiking neuron model of the second layer is scattered over a range of approximately 20 milliseconds to approximately 70 milliseconds of elapsed time from the start of data input to the spiking neural network.

In general, when processing is being executed in the spiking neural network, it is difficult to identify in real time which one of the firing timing of the spiking neural network, and the firings of the spiking neuron models in the first and second layers is influencing the firing of the spiking neuron model in the output layer.

Therefore, depending on the spiking neural network method, it is necessary to wait at least for time T11 until the spiking neuron model first fires in the output layer, without inputting the next input data to the spiking neural network. In order to strictly ensure that there is no interference in the spiking neural network between the input data that the spiking neural network processes sequentially, it is necessary to wait for the next input data without inputting it to the spiking neural network, until the last spiking neuron model fires in the output layer.

On the other hand, in the case where there are multiple sets of input data to be processed in sequence, if the next input data can be input to the spiking neural network before the solution for one input data is obtained, it is possible to comparatively reduce the amount of time required from inputting the first input data to the spiking neural network to obtaining the answer for the last input data. In this respect, it is possible to increase the throughput of the spiking neural network.

Accordingly, in the neural network device 10, a data processing time of the neuron model 100 is set so that the neuron model 100 completes data processing within the data processing time. As a result, the next data can be input to the neuron model 100 after the data processing time has elapsed.

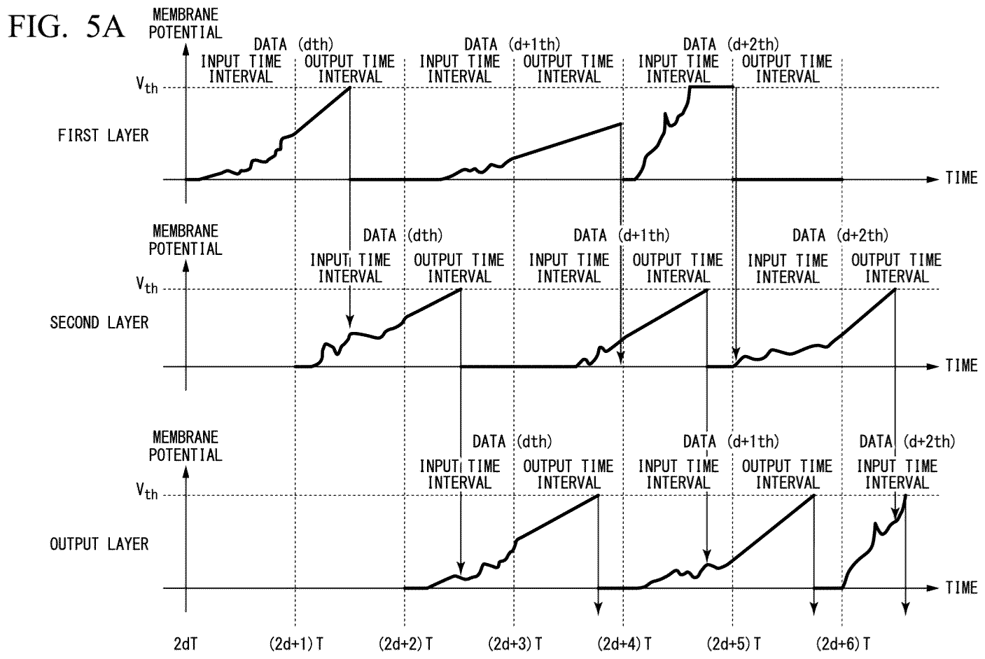

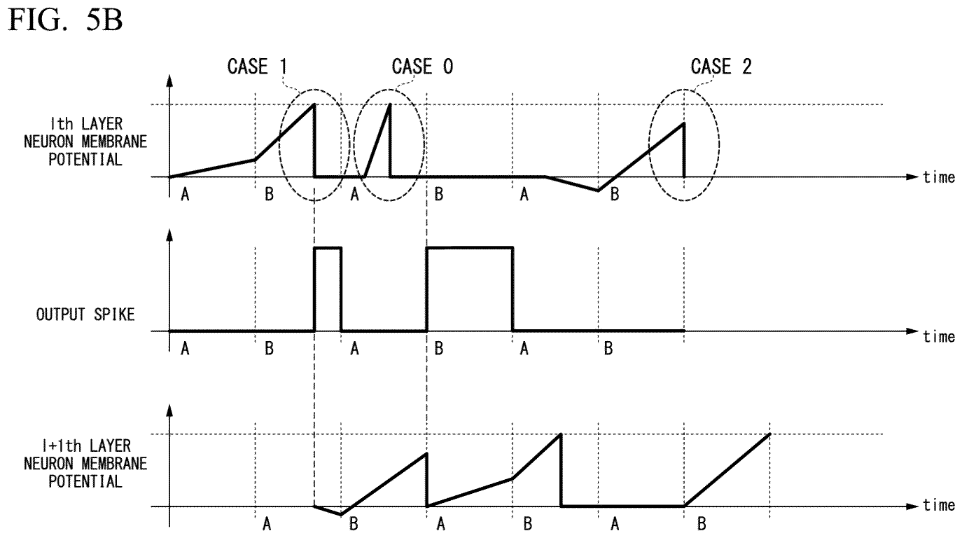

FIG. 5A and FIG. 5B are diagrams showing an example of timings of passing spike signals between the neuron models 100 in the neural network device 10. FIG. 5A shows an example of temporal changes in the membrane potential and firing timing based on the membrane potential of each neuron model 100 involved in passing spike signals, for each of the first layer to the third layer of the neural network 11. The horizontal axis of the graph in FIG. 5A indicates time as elapsed time since the first input data was input to the first layer. The vertical axis indicates the membrane potential of each neuron model 100 from the first layer to the third layer.

In the example of FIG. 5A, the data processing time set for the neuron model 100 is composed of a combination of input time intervals and output time intervals. The input time interval is a time interval in which the neuron model 100 receives input of spike signals. The output time interval is a time interval in which the neuron model 100 outputs spike signals.

The neural network device 10 synchronizes the neuron models 100 for each layer and sets the same input time intervals and the same output time intervals, so that the same data processing time is set for all the neuron models 100 included in the same layer. T is the time width of each time interval.

Moreover, the neural network device 10 also synchronizes the layers so that the output time interval of the neuron model 100 of a certain layer and the input time interval of the neuron model 100 of the next layer overlap.

In particular, the time length of the input time interval and the time length of the output time interval are set to the same length, and the input time interval and output time interval are set so that the output time interval of the neuron model 100 of a certain layer and the input time interval of the neuron model 100 of the next layer completely overlap.

In such a case, the “neuron model 100 of a certain layer” corresponds to an example of the first neuron model. The “neuron model 100 of the next layer” corresponds to an example of the second neuron model. The output time interval and the input time interval are set so that the output time interval of the first neuron model and the input time interval of the second neuron model that receives input of spike signals from the first neuron model overlap.

Since the time during which spike signals are input to the neuron model 100 is limited to the input time interval, the index value calculation unit 110 calculates the membrane potential so as to change the membrane potential over time based on the input status of the spike signal within the input time interval. The index value calculation unit 110 corresponds to an example of the index value calculation means.

In the following, as with the description of the spiking neural network with reference to Expression (1) and Expression (2), the neuron model 100 of the ith node of the lth layer is referred to as the target model, and the membrane potential of the target model is represented as vᵢ^{(l)}(t).

The index value calculation unit 110 of the example embodiment uses Expression (1A) below instead of the Expression (1) described above. By using Expression (1A), the rate of change of the membrane potential vᵢ^{(l)} (t) can be changed between the input time interval and the output time interval.

$$\begin{matrix}[ Expression 2 ] & \\ \frac{d}{dt} {v}_{i}^{( l )} ( t ) = \{ \begin{matrix}{\sum }_{j} {w}_{ij}^{( l )} θ ( t - {t}_{j}^{* ( l - 1 )} ) , & when t < lT \\ {w}_{i}^{( l )} , & when t \geq lT\end{matrix} & ( 1 A )\end{matrix}$$

wᵢⱼ^{(l)} represents the weight set in the transmission path of the spike signal from the jth spiking neuron model of the l−1th layer to the target model. wᵢ^{(l)} is the unique weight of the ith neuron in the lth layer. The rate of change in the membrane potential vᵢ^{(l)}(t) until time t reaches lT is a function using the weight coefficient wᵢⱼ^{(l)}. Accordingly, the rate of change in the membrane potential vᵢ^{(l)} (t) in the input time interval is calculated, using a function using the weight coefficient wᵢⱼ^{(l)}. Moreover, the rate of change in the membrane potential vᵢ^{(l)}(t) in the output time interval until time t reaches lT and thereafter is a function using the weight coefficient w(i)^{(l)}. For example, the function may be a linear function whose slope is the weighting coefficient w(i). The weight wᵢ^{(l)} can take positive values. Accordingly, the rate of change in the membrane potential vᵢ^{(l)} (t) in the output time interval is calculated, using a function using the weight coefficient w(l). It is preferable that the weights wᵢⱼ^{(l)} and wᵢ^{(l)} be used as targets of learning. Moreover, the weight set in the transmission path of spike signals from the jth spiking neuron model of the l−1th layer to the target model is expressed as wᵢⱼ^{(l)}.

The description regarding the neuron model 100 of the target model applies to all neuron models 100 included in the neural network device 10, except that the output timing of spike signals of the neuron model 100 in the output layer, which will be described later, may be relaxed. That is to say, the lth layer may be any layer that includes the neuron model 100 as a node. Any neuron model 100 in the lth layer may be the ith neuron model 100.

By using Expression (1A) in this manner, the membrane potential vᵢ^{(l)} (t) of the neuron model 100 changes within the output time interval with the slope wᵢ^{(l)} unique to the output time interval. Alternatively, a similar function can be realized by fixing the membrane potential within the output time interval and changing the firing threshold value instead of the threshold value Vₜₕ. Specifically, in each neuron model, the firing threshold value may be set to a unique value determined for each neuron model, and the firing threshold value may be changed with a slope −wᵢ^{(l)} in the output time interval. Note that a case will be exemplified below wherein the firing threshold value is fixed at the threshold value Vₜₕ in the output time interval and the membrane potential vᵢ^{(l)} (t) changes, however, a similar discussion can apply to a case where the membrane potential is fixed in the output time interval and the firing threshold value changes.

Hereinafter, the membrane potential v(i)(t) will be described for the input time interval and the output time interval separately.

The index value calculation unit 110 calculates the membrane potential vᵢ^{(l)} (t), using the input time interval expression where the differential equation is Expression (1A), until the membrane potential vᵢ^{(l)}(t) reaches the threshold value Vₜₕ or until the data processing time corresponding to the end of the input time interval has elapsed, whichever comes first. The membrane potential vᵢ^{(l)} (t) in the input time interval is expressed as in Expression (3A). The membrane potential vᵢ(i)(t) in the output time interval is expressed as in Expression (3B).

$$\begin{matrix}[ Expression 3 ] & \\ {v}_{i}^{( l )} ( t ) = {\sum }_{j} {w}_{ij}^{( l )} ( t - {t}_{j}^{* ( l - 1 )} ) θ ( t - {t}_{j}^{* ( l - 1 )} ) & ( 3 A )\end{matrix}$$

$${v}_{i}^{( l )} ( t ) = {v}_{i}^{( l )} ( lT ) + {w}_{i}^{( l )} ( t - {t}_{j}^{* ( l )} ) \qquad ( 3 B )$$

The index value calculation unit 110 may calculate the membrane potential vᵢ^{(l)} (t) in each interval, based on Expression (3A) and Expression (3B) mentioned above.

In the input time interval, the index value calculation unit 110 changes the membrane potential vᵢ^{(l)}(t) at a rate of change depending on the input status of spike signals to the target model as shown in Expression (1A) and Expression (3A).

On the other hand, in the output time interval, as shown in Expression (1A), spike signals to the target model are not accepted. Therefore, if the membrane potential vᵢ^{(l)} (t) does not reach the threshold value Vₜₕ within the input time interval, in the output time interval, based on the membrane potential vᵢ( )(lT) at the end of the input time interval and the elapsed time, the index value calculation unit 110 changes the membrane potential vᵢ^{(l)} (t) so that this potential increases monotonically. The expression shown as Expression (3B) is an example of this. It is preferable that the rate of change of the membrane potential vᵢ^{(l)}(t) during the output time interval be maintained at a predetermined value.

First, the membrane potential vᵢ^{(l)}(t) in the input time interval will be described in more detail.

If the time when the membrane potential v(i)(t) reaches the threshold value Vₜₕ within the input time interval is expressed as tᵢ^{(l, vth)} and substituted for time t in Expression (3A), Expression (4) is obtained. This Expression (4) is applied to the input time interval.

$$\begin{matrix}[ Expression 4 ] & \\ {V}_{th} = {v}_{i}^{( l )} ( {t}_{i}^{( l , vth )} ) = {\sum }_{j ∈ {Γ}_{i}^{( l )}} {w}_{ij}^{( l )} ( {t}_{i}^{( l , vth )} - {t}_{j}^{* ( l - 1 )} ) & ( 4 )\end{matrix}$$

“ᵢ^{(l)}” represents a set of indices j where tⱼ*^{(l-1)}<tᵢ^{(l, vth)}.

In the neural network device 10, since the firing time is limited within the output time interval, the firing time tᵢ*^{(l)} may be later than the time at which the membrane potential vᵢ^{(l)}(t) reaches the threshold value Vₜₕ in some cases. Therefore, the time at which the membrane potential vᵢ^{(l)} (t) reaches the threshold value Vₜₕ is expressed as tᵢ^{(l, vth)}. The time at which the membrane potential reaches the threshold value is also referred to as threshold value reaching time.

From Expression (4), the threshold value reaching time tᵢ^{(l, vth)} is expressed as Expression (5A).

Next, the membrane potential vᵢ^{(l)} (t) in the output time interval will be described in more detail.

The index value calculation unit 110 calculates the membrane potential vᵢ^{(l)} (t) where the differential equation is expressed as Expression (1A), until the membrane potential vᵢ^{(l)}(t) reaches the threshold value Vₜₕ or until the data processing time corresponding to the end of the output time interval has elapsed, whichever comes first. The membrane potential vᵢ^{(l)}(t) is expressed as in Expression (3B) described above. By rearranging the linear expression of Expression (3B), the threshold value reaching time tᵢ^{(l, vth)} is expressed as Expression (5B).

$$\begin{matrix}[ Expression 5 ] & \\ {t}_{i}^{( l , vth )} = \{ \begin{matrix}\frac{{V}_{th} + {\sum }_{j ∈ {Γ}_{i}^{( l )}} {w}_{ij}^{( l )} {t}_{j}^{* ( l - 1 )}}{{\sum }_{j ∈ {Γ}_{i}^{( l )}} {w}_{ij}^{( l )}} , & when {t}_{i}^{( l , vth )} < lT \\ lT + \frac{{V}_{th} - {v}_{i}^{( l )} ( lT )}{{w}_{i}^{( l )}} , & when {t}_{i}^{( l , vth )} \geq lT\end{matrix} & \begin{matrix}( 5 A ) \\ ( 5 B )\end{matrix}\end{matrix}$$

The comparison unit 120 compares the membrane potential vᵢ^{(l)} (t) and the threshold value Vₜₕ and determines whether or not the membrane potential vᵢ^{(l)}(t) has reached the threshold value Vₜₕ.

The signal output unit 130 outputs a spike signal within the output time interval based on the membrane potential vᵢ^{(l)} (t). Specifically, if the membrane potential vᵢ^{(l)} (t) reaches the threshold value Vₜₕ within the input time interval, the signal output unit 130 outputs a spike signal at the start of the output time interval. If the membrane potential vᵢ^{(l)}(t) reaches the threshold value Vₜₕ within the output time interval, then when the membrane potential v(i)(t) reaches the threshold value Vₜₕ, the signal output unit 130 outputs a spike signal. If the membrane potential vᵢ^{(l)}(t) does not reach the threshold value Vₜₕ within the output time interval, the signal output unit 130 outputs a spike signal at the end of the output time interval.

Note that in the example of FIG. 5A, since there is no spike signal destination for the output layer, spikes can be output even in the time interval corresponding to the input time interval. The time interval corresponding to the input time interval in such a case is also referred to as input/output time interval.

Hereinafter, with reference to FIG. 5B, changes in the membrane potential vᵢ^{(l)} (t) of the neuron model 100 will be described in several cases.

FIG. 5B shows an example of a spike signal passed from the lth layer to the l+1th layer of the neural network 11. The horizontal axis of the graph in FIG. 5B indicates time as elapsed time since the first input data was input to the lth layer. The vertical axis indicates the membrane potential of the neuron model 100 in the lth layer and the output spikes thereof, and the membrane potential vᵢ(i)(t) of the neuron model 100 in the 1+1th layer, starting from the upper side of FIG. 5B. In FIG. 5B, the interval A indicates an input time interval, and the interval B indicates an output time interval.

As shown with CASE0 in FIG. 5B, if the membrane potential vᵢ^{(l)} (t) reaches the threshold value Vₜₕ within the input time interval, the index value calculation unit 110 may calculate the membrane potential vᵢ^{(l)}(t) to be equal to the threshold value Vₜₕ until the start of the output time interval. As a result, at the start of the output time interval, the comparison unit 120 determines that the membrane potential vᵢ^{(l)} (t) has reached the threshold value Vₜₕ. The signal output unit 130 outputs a spike signal at the start of the output time interval, based on the determination result of the comparison unit 120.

Also, in such a case, instead of the above as shown in FIG. 5B as CASE0, after the comparison unit 120 determines that the membrane potential v(i)(t) has reached the threshold value Vₜₕ at the start of the output time interval, the index value calculation unit 110 may calculate the membrane potential vᵢ^{(l)} (t) as 0 until the start of the next input time interval. Accordingly, the index value calculation unit 110 may start processing the next data in the next input time interval from the state where the membrane potential vᵢ^{(l)}(t) is reset to zero.

Note that if the membrane potential vᵢ^{(l)}(t) has not reached the threshold value Vₜₕ within the input time interval, then as will be described below, control can be performed in several cases for the membrane potential vᵢ until the spike signal is output. The index value calculation unit 110 performs control to output a spike signal within the output time interval.

For example, as shown with CASE1 in FIG. 5B, if the membrane potential vᵢ^{(l)} (t) reaches the threshold value Vₜₕ within the output time interval, the comparison unit 120 determines the membrane potential vᵢ^{(l)}(t) as having reached the threshold value Vₜₕ. The signal output unit 130 outputs a spike signal, based on the determination result of the comparison unit 120. As a result, the signal output unit 130 outputs a spike signal at the time when the membrane potential vᵢ^{(l)} (t) reaches the threshold value Vₜₕ.

Also, in such a case, after the comparison unit 120 determines that the membrane potential vᵢ^{(l)}(t) has reached the threshold value Vₜₕ, the index value calculation unit 110 may calculate the membrane potential vᵢ^{(l)}(t) as 0 until the start of the next input time interval. Accordingly, the index value calculation unit 110 may start processing the next data in the next input time interval from the state where the membrane potential vᵢ^{(l)}(t) is reset to zero.

As shown with CASE2 in FIG. 5B, if the membrane potential vᵢ^{(l)} (t) does not reach the threshold value Vₜₕ before the end of the output time interval, the index value calculation unit 110 or the comparison unit 120 may output a spike signal to the signal output unit 130 at the end of the output time interval. The output of a spike signal in such a case is also referred to as forcible firing.

For example, if the membrane potential vᵢ^{(l)} (t) does not reach the threshold value Vₜₕ before the end of the output time interval, the comparison unit 110 may output a dummy determination result that indicates the membrane potential having reached the threshold value. The signal output unit 130 may then output a spike signal at the end of the output time interval, based on the determination result of the comparison unit 120.

If the membrane potential vᵢ^{(l)}(t) does not reach the threshold value Vₜₕ before the end of the output time interval, the index value calculation unit 110 may calculate the membrane potential vᵢ^{(l)}(t) as 0 at the start of the next input time interval. Accordingly, the index value calculation unit 110 may start processing the next data in the next input time interval from the state where the membrane potential vᵢ^{(l)} (t) is reset to zero.

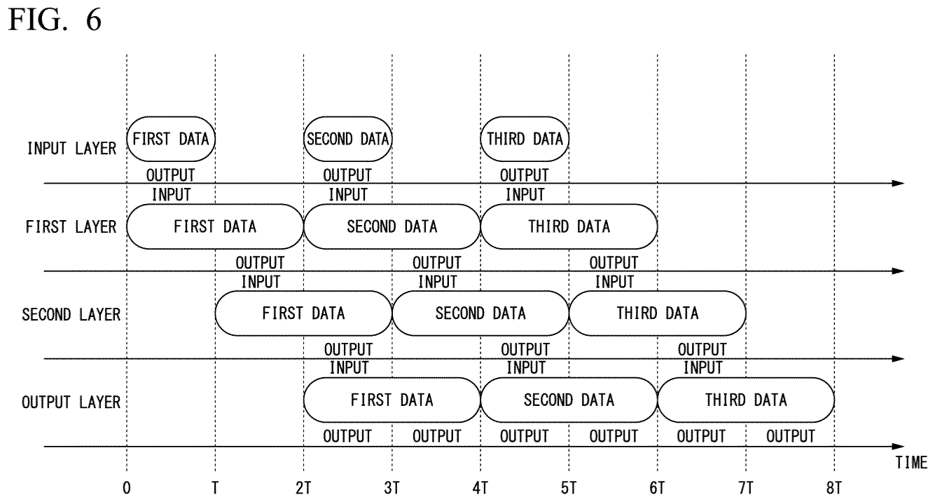

FIG. 6 is a diagram showing an example of setting time intervals. The horizontal axis in FIG. 6 indicates time as elapsed time from the start of data input to the spiking neural network 11. Input and output of data between layers are performed through input and output of spike signals.

In the example of FIG. 6, the time shown on the horizontal axis is divided into time intervals of each time T. Moreover, FIG. 6 shows the types of time intervals for each of the input layer, the first layer, the second layer, and the output layer. Specifically, the input time interval is indicated as “input”, and the output time interval is indicated as “output”. Furthermore, the input and output time intervals are indicated as “input” and “output”, respectively.

Moreover, FIG. 6 shows an example in which the neural network 11 processes three sets of data, namely, first data, second data, and third data. For each layer, the time interval for processing each data in that layer is shown.

In the example of FIG. 6, the neuron model 100 in each of the first layer, the second layer, and the third layer operates so as to complete data processing within one input time interval, one output time interval following that input time interval, and data processing time. Specifically, if the membrane potential vᵢ^{(l)}(t) does not reach the threshold value Vₜₕ by the end of the output time interval, each neuron model 100 outputs a spike signal and ends the process.

This enables the neuron model 100 to process the next data in the next data processing time. The neural network 11 as a whole can start processing the next data without waiting for the completion of processing the input data, as in so-called pipeline processing.

Also, in the example of FIG. 6, the neural network device 10 synchronizes the layers and synchronizes the neuron models 100 in each layer, so that the output time interval of the layer that outputs a spike signal matches the input time interval of the layer that receives the input of the spike signal. That is to say, the neural network device 10 synchronizes the layers and synchronizes the neuron models 100 in each layer, so that the output time interval of the layer that outputs a spike signal completely overlaps with the input time interval of the layer that receives the input of the spike signal.

The neural network device 10 may include a synchronization processing unit, and the synchronization processing unit may notify each neuron model 100 of the timing of switching between time intervals. Alternatively, each neuron model 100 may detect the timing of switching between time intervals based on a clock signal common to all neuron models 100.

In the example of FIG. 6, the processing in which the ith neuron model 100 of the lth layer outputs a spike signal in the output time interval in processing the first data can be expressed as Expression (6).

$$\begin{matrix}[ Expression 6 ] & \\ {t}_{i}^{( l )} = clip ( {t}_{i}^{( l , vth )} , lT , ( l + 1 ) T ) & ( 6 )\end{matrix}$$

Expression clip is expressed as Expression (7).

$$\begin{matrix}[ Expression 7 ] & \\ clip ( x , a , b ) = \{ \begin{matrix}a & when x < a \\ x & when a \leq x < b \\ b & when b \leq x\end{matrix} & ( 7 )\end{matrix}$$

The function clip shown in Expression (7) is referred to as a clip function.

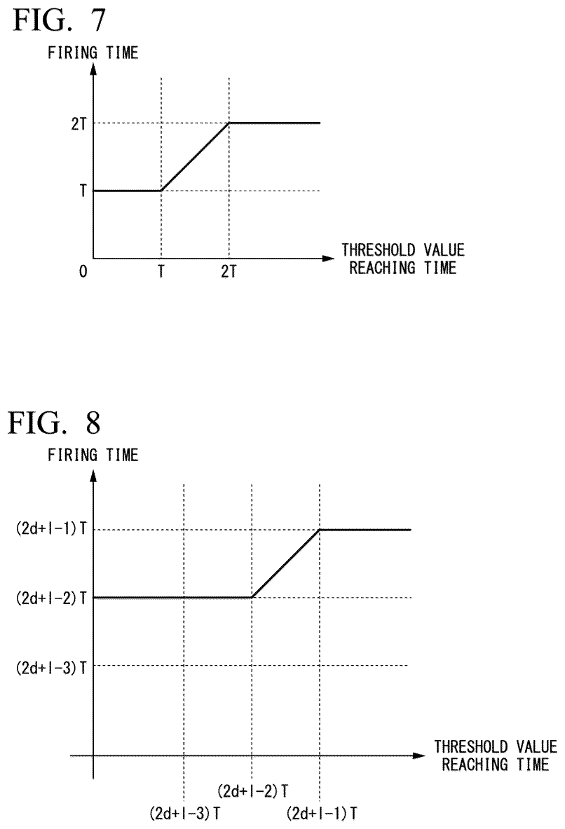

FIG. 7 is a diagram showing a first example of the clip function. FIG. 7 shows an example of the clip function when the neuron model 100 in the first layer processes the first data in the example of FIG. 6.

The horizontal axis of the graph in FIG. 7 indicates the time at which the membrane potential vᵢ^{(l)}(t) reaches the threshold value Vₜₕ in terms of elapsed time from the start of data input to the neural network 11. The vertical axis indicates the time at which the neuron model 100 outputs a spike signal, expressed as the elapsed time from the start of data input to the neural network 11. Both the horizontal axis and the vertical axis in FIG. 7 correspond to the horizontal axis in FIG. 6.

As shown in FIG. 7, if the threshold value reaching time tᵢ^{(l, vth)} is earlier than time T, the neuron model 100 outputs a spike signal at time T. Time T is the start time of the output time interval.

If the threshold value reaching time tᵢ^{(l, vth)} is within the interval from time T to time 2T, the neuron model 100 outputs a spike signal at the threshold value reaching time tᵢ^{(l, vth)}. Time 2T is the end time of the output time interval. Note that it is assumed that the delay time from the moment at which the membrane potential vᵢ^{(l)} (t) reaches the threshold value Vₜₕ to the moment at which the neuron model 100 outputs a spike signal can be ignored.

If the threshold value reaching time tᵢ^{(l, vth)} is later than time 2T, that is to say, if the membrane potential vᵢ^{(l)} (t) has not reached the threshold value Vₜₕ by time 2T, the neuron model 100 outputs a spike signal at time 2T.

In the example of FIG. 6, the processing in which the ith neuron model 100 of the lth layer outputs a spike signal in the output time interval in processing the dth data can be expressed as Expression (8).

$$\begin{matrix}[ Expression 8 ] & \\ {t}_{i}^{* ( l )} = clip ( {t}_{i}^{( l , vth )} , ( 2 d + l - 2 ) lT , ( 2 d + l - 1 ) T ) & ( 8 )\end{matrix}$$

FIG. 8 is a diagram showing a second example of the clip function. In FIG. 8, the example in FIG. 7 is more generalized. Specifically, FIG. 8 shows an example of the clip function when the neuron model 100 in the lth layer processes the dth data in the example of FIG. 6.

The horizontal axis of the graph in FIG. 8 indicates the time at which the membrane potential vᵢ^{(l)}(t) reaches the threshold value Vₜₕ in terms of elapsed time from the start of data input to the neural network 11. The vertical axis indicates the time at which the neuron model 100 outputs a spike signal, expressed as the elapsed time from the start of data input to the neural network 11. Both the horizontal axis and the vertical axis in FIG. 8 correspond to the horizontal axis in FIG. 6.

As shown in FIG. 8, if the threshold value reaching time tᵢ^{(l, vth)} is earlier than time (2d+l−2)T, the neuron model 100 outputs a spike signal at time T. Time (2d+1-2)T is the start time of the output time interval.

If the threshold value reaching time tᵢ^{(l, vth)} is within the interval from time (2d+1-2)T to time (2d+l−1)T, the neuron model 100 outputs a spike signal at the threshold value reaching time tᵢ^{(l, vth)}. Time (2d+l−1)T is the end time of the output time interval. Note that it is assumed that the delay time from the moment at which the membrane potential vᵢ^{(l)}(t) reaches the threshold value Vₜₕ to the moment at which the neuron model 100 outputs a spike signal can be ignored.

If the threshold value reaching time t^{(l, vth)} is later than time (2d+l−1)T, that is to say, if the membrane potential vᵢ^{(l)(t)} has not reached the threshold value Vₜₕ by time (2d+l−1)T, the neuron model 100 outputs a spike signal at time (2d+l−1)T.

The clip function in the neuron model 100 can be regarded as equivalent to the activation function in an artificial neural network (ANN). Therefore, in the neural network 11, it can be understood that the concept of activation function is introduced into the spiking neural network. In this respect, it is expected that the neural network device 10 will exhibit high recognition performance.

Moreover, the clip function in the neuron model 100 may be the learning target.

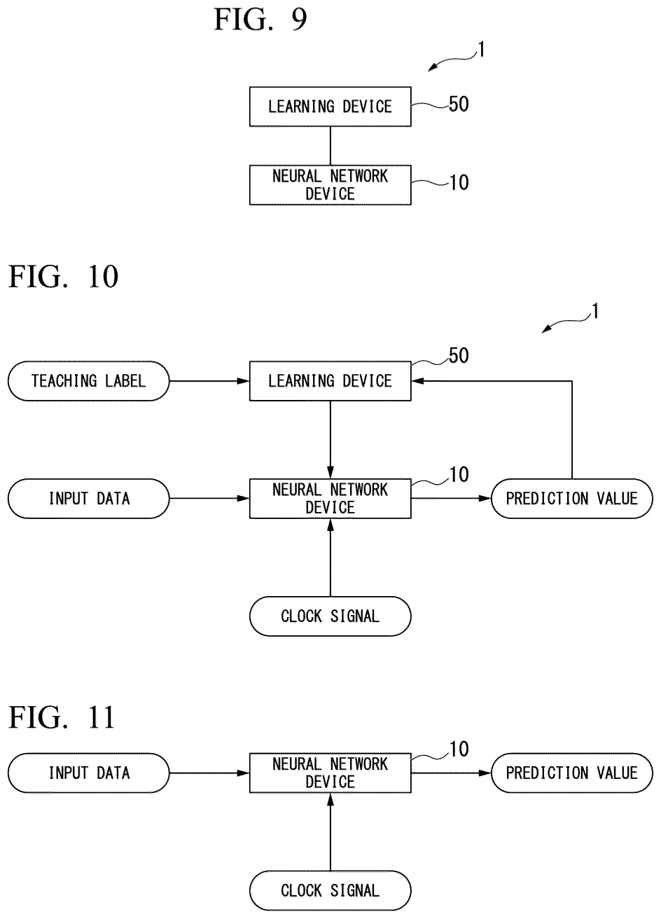

FIG. 9 is a diagram showing an example of a system configuration at the time of performing learning. With the configuration shown in FIG. 9, the neural network system 1 includes the neural network device 10 and a learning device 50. The neural network device 10 and the learning device 50 may be integrally configured as one device. Alternatively, the neural network device 10 and the learning device 50 may be configured as separate devices.

As described above, the neural network 11 configured by the neural network device 10 is also referred to as neural network main body.

FIG. 10 is a diagram showing an example of signal input/output in the neural network system 1.

In the example of FIG. 10, input data and a teaching label indicating true for the input data are input to the neural network system 1. The neural network device 10 may receive input data, and the learning device 50 may receive a teaching label. The combination of input data and a teaching label corresponds to an example of training data in supervised learning.

Also, the neural network device 10 acquires a clock signal. The neural network device 10 may include a clock circuit. Alternatively, the neural network device 10 may receive an input of a clock signal from outside the neural network device 10.

The neural network device 10 receives an input of input data and outputs an estimated value based on the input data. When calculating the estimated value, the neural network device 10 uses a clock signal to synchronize time intervals between layers and between neuron models 100 in the same layer.

The learning device 50 performs learning of the neural network models 10. Learning here means adjusting parameter values of a learning model by machine learning. The learning device 50 performs learning of a weight coefficient for spike signals input to the neuron model 100. The weight Wᵢⱼ^{(l)} in Expression (4) corresponds to an example of the weight coefficient the value of which is adjusted by the learning device 50 through learning.

The learning device 50 may use an evaluation function that indicates the evaluation of an error between the estimated value output by the neural network device 10 and the true value indicated by the teaching label, to perform weight coefficient learning so that the size of the error between the estimated value and the true value becomes small.

The learning device 50 corresponds to an example of the learning means. The learning device 50 is configured, using a computer, for example.

As a learning method performed by the learning device 50, for example, an existing learning method such as backpropagation arranged according to the set input time interval and output time interval may be used.

For example, in the case where the learning device 50 performs learning using an arranged backpropagation method, the weight Wᵢⱼ^{(l)} may be updated so as to change the weight Wᵢⱼ^{(l)} by the amount of change ΔWᵢⱼ(j) shown in Expression (9A). Similarly, the weight Wi^{(l)} may be updated so as to change the weight Wi^{(l)} by the amount of change ΔWi^{(l)} shown by Expression (9B).

$$\begin{matrix}[ Expression 9 ] & \\ Δ {w}_{ij}^{( l )} = - η \frac{\partial C}{\partial {w}_{ij}^{( l )}} & ( 9 A )\end{matrix}$$

$$Δ {w}_{i}^{( l )} = - η \frac{\partial C}{\partial {w}_{i}^{( l )}} \qquad ( 9 B )$$

η is a constant indicating the learning rate. The learning rates in Expression (9A) and Expression (9B) may be the same value or may be different values.

C is expressed as in Expression (10).

$$\begin{matrix}[ Expression 10 ] & \\ C := - {\sum }_{i = 1}^{{N}^{( M )}} {κ}_{i} ln ( {S}_{i} ( {t}^{( M )} ) ) + \frac{γ}{2} {( {t}_{i}^{* ( M )} - {t}^{( ref )} )}^{2} & ( 10 )\end{matrix}$$

C corresponds to an example of the evaluation function that indicates the evaluation of an error between the estimated value output by the neural network device 10 and the true value indicated by the teaching label. C is set as a loss function that outputs a smaller value the smaller the error.

M represents an index value indicating the output layer (final layer). N^{(M)} represents the number of neuron models 100 included in the output layer.

κᵢ represents a teaching label. Here, it is assumed that the neural network device 10 performs class classification in which the number of classes is N^{(M)}, and that the teaching label is indicated by a one-hot vector. It is assumed that κᵢ=1 when the value of index i indicates the true class, and κᵢ=0 otherwise.

t(^{re}f represents a reference spike.

“γ/2(tᵢ^{(M)}−t^{(ref)2}” is a term provided to avoid learning difficulties. This term is also referred to as temporal penalty term. γ is a constant for adjusting the degree of influence of the temporal penalty term, and γ>0. γ is also referred to as a temporal penalty coefficient.

Sᵢ is a softmax function and is expressed as Expression (11).

$$\begin{matrix}[ Expression 11 ] & \\ {S}_{i} ( {t}^{( M )} ) := \frac{exp ( - \frac{{t}_{i}^{* ( M )}}{{σ}_{soft}} )}{{\sum }_{j = 1}^{{N}^{( M )}} exp ( - \frac{{t}_{j}^{* ( M )}}{{σ}_{soft}} )} & ( 11 )\end{matrix}$$

σ_{soft} is a constant provided as a scale factor for adjusting the magnitude of the value of the softmax function Sᵢ, and σ_{soft}>0.

Here, it is assumed that the ith spike firing time tᵢ^{(M)} of the output layer is expressed as 0≤tᵢ^{(M)}≤1. For example, the spike firing time of the output layer may indicate, for each class, the probability of the classification target indicated by the input data being classified into that class. For i where κᵢ=1, the closer the value of tᵢ^{(M)} is to 1, the smaller the value of the term “−Σᵢ₌₁^{N(M)}(κᵢln(Sᵢ(t^{(M)})))” becomes, and the learning device 50 calculates a smaller loss (value of evaluation function C).

However, the processing performed by the neural network device 10 is not limited to class classification.

In addition to or instead of the weights Wᵢⱼ^{(l)} and Wᵢ^{(l)}, the clip function in the neuron model 100 may be the learning target, as described above. For example, “a” and “b” in Expression (7) may be treated as learning parameters, and the values of “a” and “b” may be adjusted during learning. Moreover, for example, the learning device 50 may determine the time widths of the input time interval and the output time interval through learning, and set the values of “a” and “b” according to the obtained time widths. In FIG. 6, time T corresponds to an example of the time width of the input time interval and the output time interval.

FIG. 11 is a diagram showing an example of signal input/output in the neural network device 10 at the time of operating.

Similar to the operation shown in FIG. 10, also during learning, the neural network device 10 receives input data and also acquires a clock signal. The neural network device 10 may include a clock circuit. Alternatively, the neural network device 10 may receive an input of a clock signal from outside the neural network device 10.

The neural network device 10 receives an input of input data and outputs an estimated value based on the input data. When calculating the estimated value, the neural network device 10 uses a clock signal to synchronize time intervals between layers and between neuron models 100 in the same layer.

Next, the results of an experiment using the neural network device 10 will be described.

Learning and testing of handwritten digit image recognition were performed, using MNIST, a dataset of handwritten digit images.

The configuration of the neural network 11 was a fully connected forward propagation type having four layers, namely, an input layer, a first layer, a second layer, and an output layer. The number of neuron models 100 in the input layer was 784, the number of neuron models 100 in the first and second layers was 200 each, and the number of neuron models 100 in the output layer was 10.

The time widths of the input time interval and the output time interval were both 0.05 milliseconds.

As a method for presenting the estimation result yielded by the neural network 11, a time method was adopted in which the estimation result is presented depending on which neuron model 100 among the neuron models 100 in the output layer outputs a spike signal first.

As a result of the experiment, a recognition rate of 97.4% was obtained during the test.

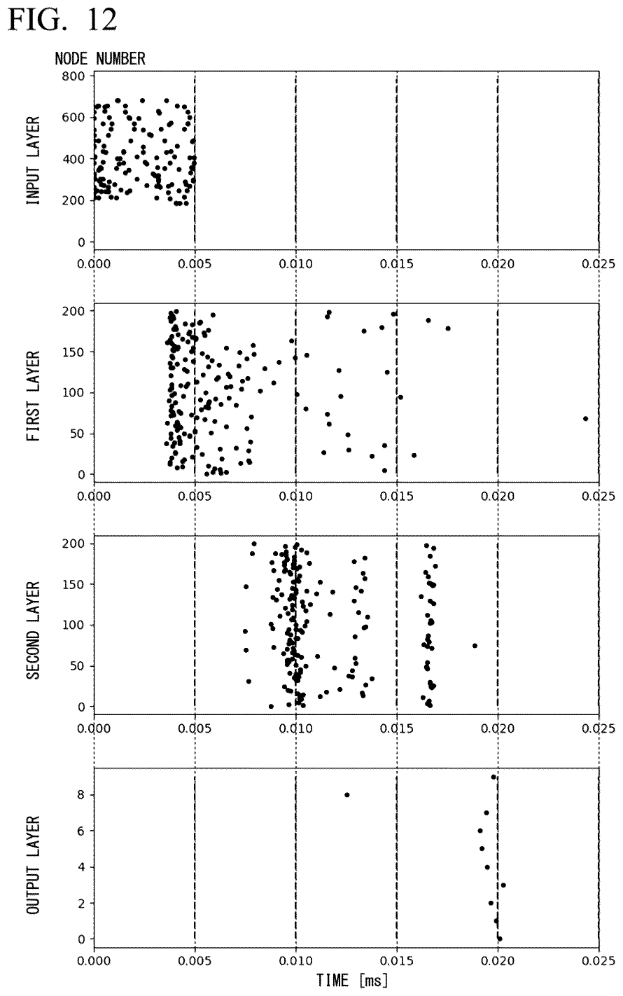

FIG. 12 is a diagram showing an example of threshold value reaching times at the time of performing learning. FIG. 12 shows an example of the threshold value reaching time in the case where the index value calculation unit 110 does not limit the time for calculating the membrane potential.

The horizontal axis in FIG. 12 indicates time as elapsed time from the start of data input to the spiking neural network 11. The vertical axis indicates node numbers in each of the input layer, the first layer, the second layer, and the output layer.

In the example of FIG. 12, among the neuron models 100 in the first layer, there is a neuron model 100 the membrane potential of which reaches the threshold value after 0.010 milliseconds, which is the end of the output time interval of the first layer. For example, there is a neuron model 100 the membrane potential of which reaches the threshold value at around 0.025 milliseconds.

If the membrane potential of this neuron model 100 is to be waited to reach the threshold value, spike signals for processing the next input data cannot be input to the neuron model 100 in the first layer until around 0.025 milliseconds.

Also, regarding the second layer, among the neuron models 100 in the second layer, there is a neuron model 100 the membrane potential of which reaches the threshold value after 0.015 milliseconds, which is the end of the output time interval of the first layer. For example, there is a neuron model 100 the membrane potential of which reaches the threshold value at around 0.019 milliseconds.

If the membrane potential of this neuron model 100 is to be waited to reach the threshold value, spike signals for processing the next input data cannot be input to the neuron model 100 in the first layer until around 0.019 milliseconds.

Or, if calculation of the membrane potential in each of the first layer neuron models 100 and each of the second layer neuron models 100 is to continue until the neural network 11 outputs the estimation result, spike signals for processing the next input data cannot be input to any of the neuron model 100 in the first layer, the second layer, and the output layer until around 0.013 milliseconds, at which time the membrane potential of the neuron model 100 of the output layer first reaches the threshold value.

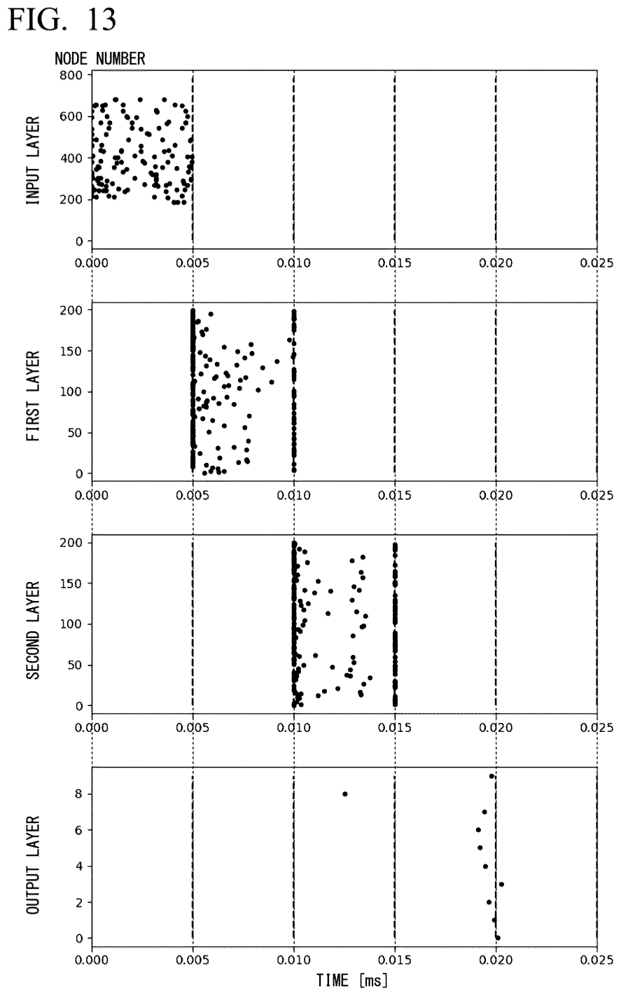

FIG. 13 is a diagram showing an example of firing times at the time of performing learning.

The horizontal axis in FIG. 13 indicates time as elapsed time from the start of data input to the spiking neural network 11. The vertical axis indicates node numbers in each of the input layer, the first layer, the second layer, and the output layer.

In the example of FIG. 13, all the neuron models 100 in the first layer output spike signals during the output time interval of the first layer from 0.005 seconds to 0.010 seconds. Accordingly, spike signals for processing the next input data can be input to the neuron model 100 in the first layer at and after 0.010 seconds.

Moreover, since the firing time of the first layer neuron model 100 is limited to 0.005 seconds or later, the start time of the input time interval of the second layer can also be set to 0.005 seconds. If there is preceding data before the processing target data of the example of FIG. 13, the second layer neuron model 100 can process the preceding data up until 0.005 seconds.

Moreover, all the neuron models 100 in the second layer output spike signals during the output time interval of the second layer from 0.010 seconds to 0.015 seconds. Accordingly, spike signals for processing the next input data can be input to the neuron model 100 in the second layer at and after 0.015 seconds.

Moreover, since the firing time of the first layer neuron model 100 is limited to 0.010 seconds or later, the start time of the input/output time interval of the output layer can also be set to 0.010 seconds. If there is preceding data before the processing target data of the example of FIG. 13, the output layer neuron model 100 can process the preceding data up until 0.010 seconds.

Note that, in the experiment, the timing at which the neuron model 100 in the output layer outputs spike signals is not limited. Accordingly, among the neuron models 100 in the output layer, there is a neuron model 100 the membrane potential of which reaches the threshold value after 0.020 milliseconds, which is the end of the output time interval of the output layer. By making the neuron model 100 of the output layer also fire within the output time interval, spike signals for processing the next input data can be input to the neuron model 100 in the output layer at and after 0.020 milliseconds, which is the end of the output time interval.

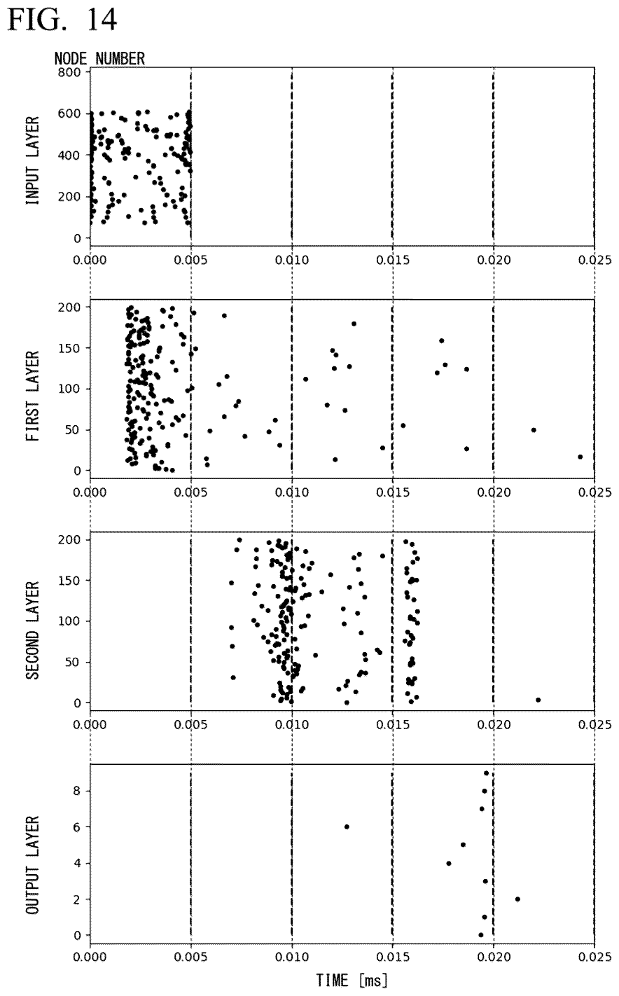

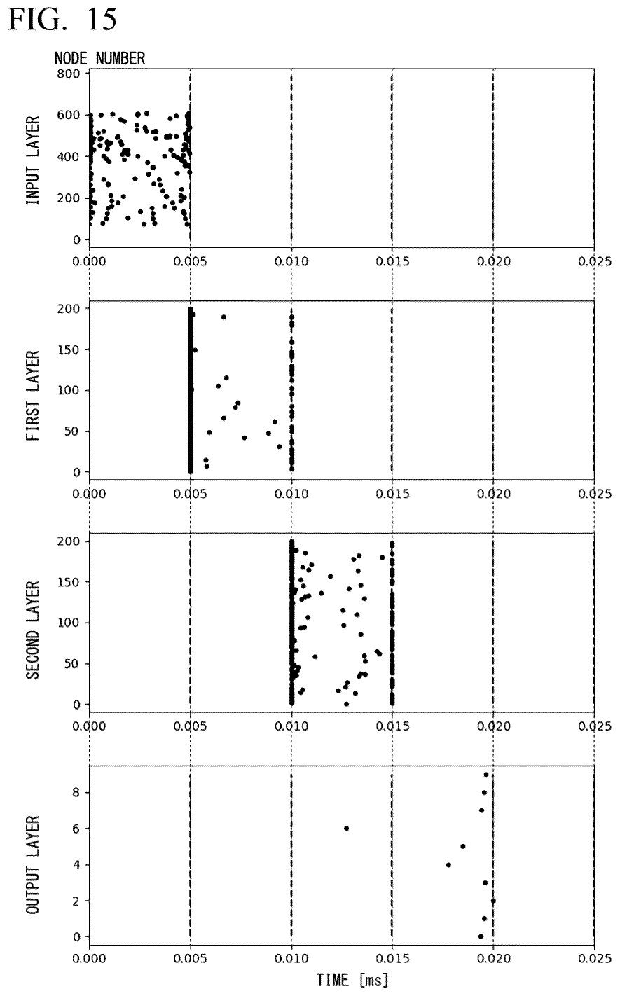

FIG. 14 is a diagram showing an example of threshold value reaching times at the time of performing testing. FIG. 14 shows an example of the threshold value reaching time in the case where the index value calculation unit 110 does not limit the time for calculating the membrane potential.

The horizontal axis in FIG. 14 indicates time as elapsed time from the start of data input to the spiking neural network 11. The vertical axis indicates node numbers in each of the input layer, the first layer, the second layer, and the output layer.

In the example of FIG. 14, among the neuron models 100 in the first layer, there is a neuron model 100 the membrane potential of which reaches the threshold value after 0.010 milliseconds, which is the end of the output time interval of the first layer. For example, there is a neuron model 100 the membrane potential of which reaches the threshold value at around 0.025 milliseconds.

If the membrane potential of this neuron model 100 is to be waited to reach the threshold value, spike signals for processing the next input data cannot be input to the neuron model 100 in the first layer until around 0.025 milliseconds.

Also, regarding the second layer, among the neuron models 100 in the second layer, there is a neuron model 100 the membrane potential of which reaches the threshold value after 0.015 milliseconds, which is the end of the output time interval of the first layer. For example, there is a neuron model 100 the membrane potential of which reaches the threshold value at around 0.022 milliseconds.

If the membrane potential of this neuron model 100 is to be waited to reach the threshold value, spike signals for processing the next input data cannot be input to the neuron model 100 in the first layer until around 0.022 milliseconds.

Or, if calculation of the membrane potential in each of the first layer neuron models 100 and each of the second layer neuron models 100 is to continue until the neural network 11 outputs the estimation result, spike signals for processing the next input data cannot be input to any of the neuron models 100 in the first layer, the second layer, and the output layer until around 0.013 milliseconds, at which time the membrane potential of the neuron model 100 of the output layer first reaches the threshold value.

FIG. 15 is a diagram showing an example of firing times at the time of performing testing.

The horizontal axis in FIG. 15 indicates time as elapsed time from the start of data input to the spiking neural network 11. The vertical axis indicates node numbers in each of the input layer, the first layer, the second layer, and the output layer.

In the example of FIG. 15, all the neuron models 100 in the first layer output spike signals during the output time interval of the first layer from 0.005 seconds to 0.010 seconds. Accordingly, spike signals for processing the next input data can be input to the neuron model 100 in the first layer at and after 0.010 seconds.

Moreover, since the firing time of the first layer neuron model 100 is limited to 0.005 seconds or later, the start time of the input time interval of the second layer can also be set to 0.005 seconds. If there is preceding data before the processing target data of the example of FIG. 15, the second layer neuron model 100 can process the preceding data up until 0.005 seconds.

Moreover, all the neuron models 100 in the second layer output spike signals during the output time interval of the second layer from 0.010 seconds to 0.015 seconds. Accordingly, spike signals for processing the next input data can be input to the neuron model 100 in the second layer at and after 0.015 seconds.

Moreover, since the firing time of the second layer neuron model 100 is limited to 0.010 seconds or later, the start time of the input/output time interval of the output layer can also be set to 0.010 seconds. If there is preceding data before the processing target data of the example of FIG. 15, the output layer neuron model 100 can process the preceding data up until 0.010 seconds.

By making the neuron model 100 of the output layer also fire within the output time interval, spike signals for processing the next input data can be input to the neuron model 100 in the output layer at and after 0.020 milliseconds, which is the end of the output time interval.

According to the example embodiment, in the neural network device 10, input time intervals for receiving spikes and output time intervals for firing and transmitting spikes are divided. The neural network device 10 includes neuron models 100 that fire within the output time intervals and are restricted from firing within the input time intervals. This makes it possible to use the input time intervals and the output time intervals in respective usage modes, and the spiking neural network becomes able to perform data processing efficiently.

For example, by transmitting a spike by firing the neuron model 100 within a certain time interval, the posterior edge of the output time interval becomes clear, and this makes it easier to make division between input time intervals in which spikes are received and output time intervals in which spikes are allowed to be transmitted. As a result, it becomes easier to make adjustments to use information from the neuron model 100 that outputs relatively significant information without information leakage. By making the neuron model 100 that outputs relatively significant information fire within the output time interval, the spiking neural network becomes able to perform data processing efficiently.

Moreover, the configuration may be such that firing of the neuron model 100 that outputs relatively insignificant information is omitted. For example, the neuron model 100 may be formed to forcibly fire in the case where the membrane potential of the neuron model 100 satisfies a predetermined condition at the posterior edge of the output time interval, or not to fire in the same case. This prevents the neuron model 100 from firing after the output time interval has elapsed. As a result, the spiking neural network becomes able to perform data processing even more efficiently.

Note that the firing time at which the neuron model 100 fires within the output time interval may be defined as a function of the membrane potential of the neuron model 100 at the last time of the input time interval. The neuron model 100 may be formed to limit firing when the membrane potential of the neuron model 100 at the last time of the input time interval is outside a predetermined range. The neuron model 100 may be formed so that the membrane potential of the neuron model 100 within the output time interval increases with a slope unique to each neuron model 100. The neuron model 100 generates a spike with a predetermined pulse waveform when the membrane potential of the neuron model 100 satisfies a predetermined condition within the output time interval. For example, the neuron model 100 can start transmitting a spike in the form of a rectangular waveform when the membrane potential of the neuron model 100 satisfies the predetermined condition within the output time interval, and stop transmitting the spike at the time when the output time interval ends.

Note that the type of neural network 11 is not limited to a particular type. For example, the neural network 11 may be configured as a convolutional neural network (CNN) using a spiking neural network.

### Second Example Embodiment

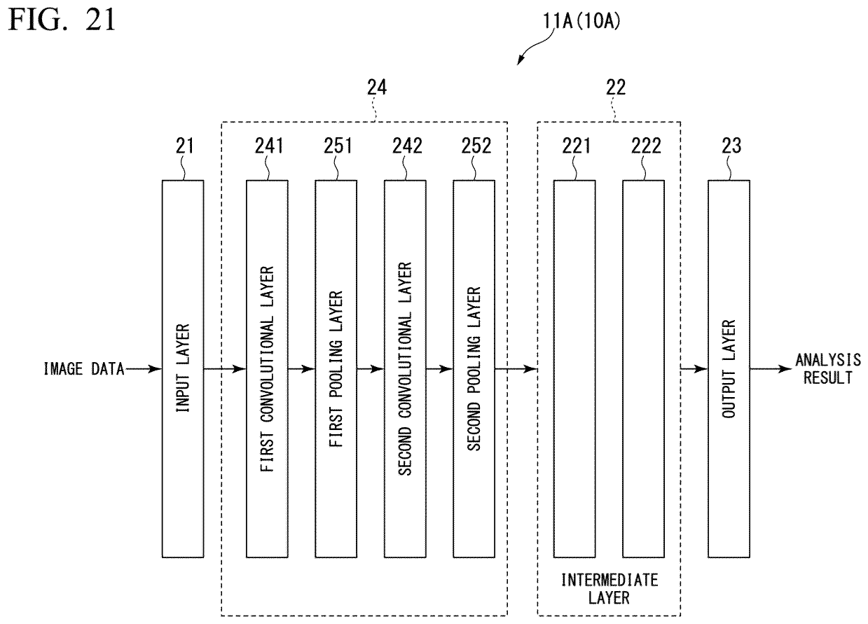

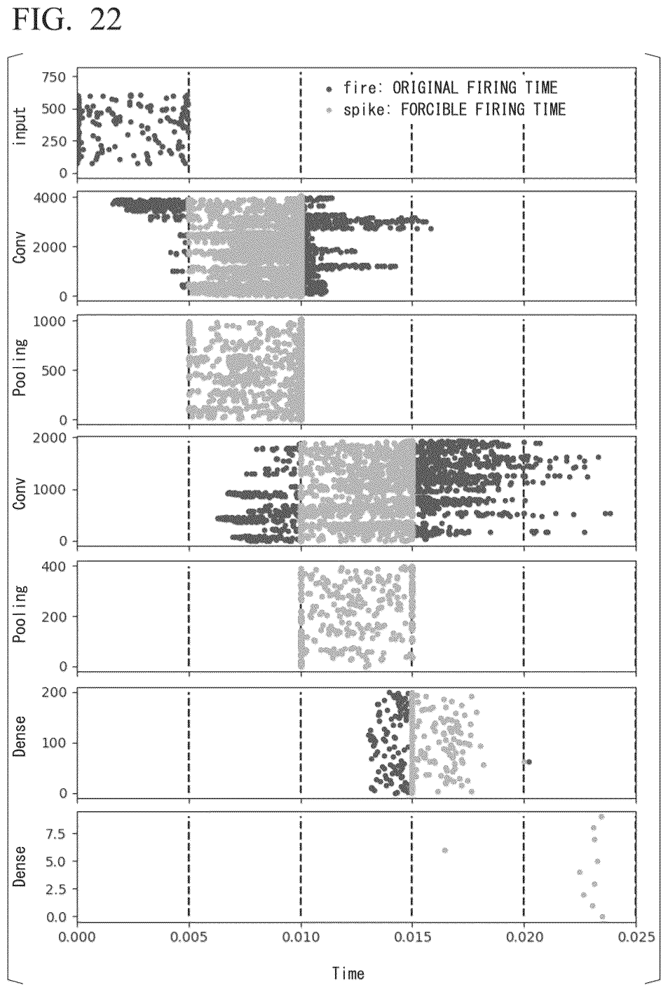

An example of application to a CNN type neural network device 10A will be described as a second example embodiment, with reference to FIG. 21 to FIG. 24.

FIG. 21 is a diagram showing a configuration example of the neural network device 10A. The neural network device 10A includes a neural network 11A. The neural network 11A is configured as a CNN. For example, the neural network 11A includes, in order from the input side, an input layer 21, an intermediate layer 22, an output layer 23, and a feature extraction layer 24.

The feature extraction layer 24 is arranged between the input layer 21 and the intermediate layer 22. The feature extraction layer 24 is configured so as to extract desired features from input image data through computing processing using the output of the input layer 21. The feature extraction layer 24 supplies the calculation results to the subsequent intermediate layer 22.

For example, the feature extraction layer 24 is configured to combine convolutional layers (Conv) and pooling layers (Pooling) so that an arbitrary number of sets of convolutional layers and pooling layers suitable for processing are stacked. The feature extraction layer 24 shown in FIG. 21 includes a first convolutional layer (Conv) 241, a first pooling layer (Pooling) 251, a second convolutional layer (Conv) 242, and a second pooling layer (Pooling) 252. The feature extraction layer 24 is an example including two sets of convolution layers and pooling layers. Each layer is composed of neuron models 100 that are activated according to local features in the image space.

The intermediate layer 22 includes, for example, a first fully-connected layer 221 (Dense) and a second fully-connected layer 222 (Dense). Note that the output layer 23 may be omitted.

Hereinafter, an example of the results of an experiment using the neural network device 10A configured as described above will be shown. Part of MNIST data is used as input data for this experiment. The data shown here is a model of a character 8 that is handwritten.

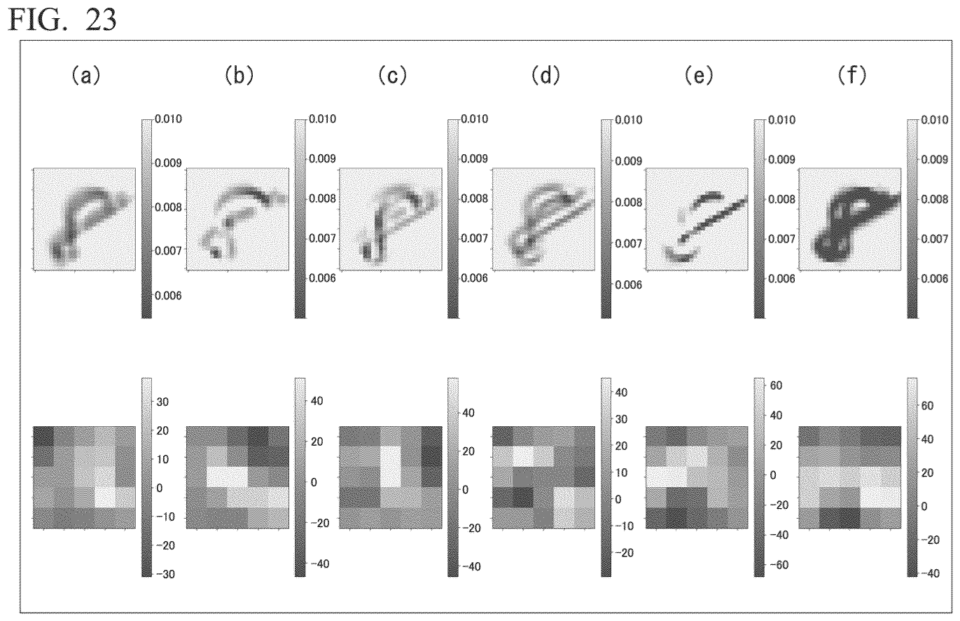

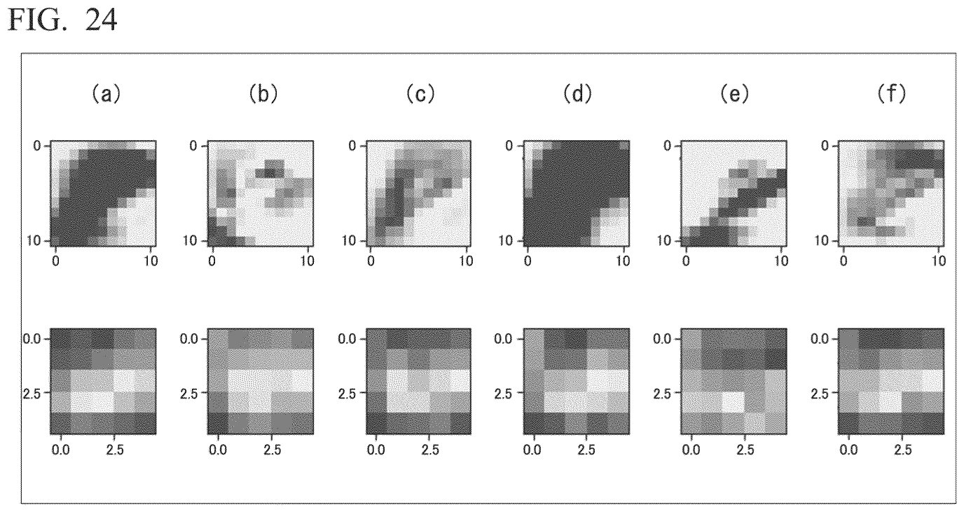

FIG. 22 is a diagram for describing the results of identification processing. FIG. 23 is a diagram for describing the output results of the first convolutional layer 241 and the first pooling layer 251. FIG. 24 is a diagram for describing the output results of the second convolutional layer 242 and the second pooling layer 252. The values of each pixel in the images shown in FIG. 23 and FIG. 24 are obtained by converting the times at which spikes in each layer were confirmed.

In order from the upper side of FIG. 22, for the input layer 21 (input), the first convolutional layer 241 (Conv), the first pooling layer 251 (Pooling), the second convolutional layer 242 (Conv), and the second pooling layer 252 (Pooling), the first fully-connected layer 221 (Dense), and the second fully-connected layer 222 (Dense), the times at which the membrane potential vᵢ^{(l)}(t) reaches the threshold value Vₜₕ are plotted.

For example, the size of the two-dimensional image to be identified is 28 pixels by 28 pixels.

The first convolutional layer 241 forms a convolution filter of size 5×5 and has this in six channels. The first pooling layer 251 performs maximum value pooling on the processing results of the first convolutional layer 241 in units of size 2×2. The second convolutional layer 242 forms a convolution filter of size 5×5 and has this in sixteen channels. The second pooling layer 252 performs maximum value pooling on the processing results of the second convolutional layer 242 in units of size 2×2. The number of neuron models 100 in the first fully-connected layer 221 is 200, and the number of neuron models 100 in the second fully-connected layer 222 is ten.

FIG. 22 shows the firing occurrence status of the neuron models 100 in each layer by marking the firing time with a circle. In each layer, it has been confirmed that the firing timings of the neuron models 100 are appropriately distributed within their output time intervals, and as a result of the computation of the second fully-connected layer 222, it has been confirmed that the neuron model 100 corresponding to the index value 8 to have fired the earliest.

The results are shown with (a) to (f) in FIG. 23 and FIG. 24. These results also confirm that there was a relatively strong activation in the diagonally upward-to-the-right direction along the locus of the character 8. As a result of the experiment, a recognition rate of 99.10% was obtained during the test.

As described above, the second example embodiment also provides the same effects as those of the first example embodiment.

### Modifications Common to Each Example Embodiment

As described above, when the neural network 11 is configured as a forward propagation spiking neural network, the number of layers may be two or more and is not limited to a specific number. Moreover, the number of neuron models 100 included in each layer is not limited to a specific number, and it is sufficient that each layer includes one or more neuron models 100. Each layer may include the same number of neuron models 100, or each layer may include a different number of neuron models 100. Also, the neural network 11 may be configured in a fully-connected manner, but may not be configured in a fully-connected manner.

Furthermore, the membrane potential of the neuron model 100 after firing is not limited to one that does not change from the potential 0 described above. For example, after a predetermined period of time has elapsed since the firing, the membrane potential may be changed in response to the input of a spike signal. The number of times each neuron model 100 fires is also not limited to once for each input data.

The configuration of the neuron model 100 as a spiking neuron model is also not limited to a specific configuration. For example, the rate of change in the neuron model 100 from receiving an input of a spike signal to receiving an input of the next spike signal may not be constant.

The learning method of the neural network 11 is not limited to supervised learning. The learning device 50 may perform the learning of the neural network 11 by unsupervised learning.

As described above, the index value calculation unit 110 changes the membrane potential over time based on the signal input status in the input time interval. The signal output unit 130 outputs a signal within the output time interval after the end of the input time interval, based on the membrane potential.

In this way, by setting the input time interval in which the neuron model 100 receives input of spike signals and the output time interval in which the neuron model 100 outputs spike signals, it is possible to restrict the time during which the index value calculation unit 110 calculates the membrane potential to the time from the start of the input time interval to the end of the output time interval. At other times, the neuron model 100 may perform processing on other data.

According to the neural network device 10, the spiking neural network is able to process data efficiently in this respect.

Moreover, the index value calculation unit 110 changes the membrane potential at a rate of change depending on the signal input status within the input time interval. If the membrane potential does not reach the threshold value within the input time interval, the index value calculation unit 110 changes the membrane potential in the output time interval at the rate of change at the end of the input time interval.

If the membrane potential reaches the threshold value within the input time interval, the signal output unit 130 outputs a spike signal at the start of the output time interval. If the membrane potential reaches the threshold value within the output time interval, the signal output unit 130 outputs a spike signal when the membrane potential reaches the threshold value. If the membrane potential does not reach the threshold value within the output time interval, the signal output unit 130 outputs a spike signal at the end of the output time interval.

As a result, it is possible to restrict the time during which the neuron model 100 outputs spike signals, to the output time interval. The neuron model 100 can process other data after the end of the output time interval.

According to the neural network device 10, the spiking neural network is able to process data efficiently in this respect.

Moreover, the output time interval and the input time interval are set so that the output time interval of the first neuron model 100 and the input time interval of the second neuron model that receives input of spike signals from the first neuron model overlap.

As a result, data can be efficiently transmitted from the first neuron model 100 to the second neuron model 100 by spike signals, and the first neuron model 100 and the second neuron model 100 can perform processing in a pipeline processing-like manner.

According to the neural network device 10, the spiking neural network is able to process data efficiently in this respect.

Also, the index value calculation unit 110 changes the membrane potential over time based on the signal input status in the input time interval. The signal output unit 130 outputs a spike signal within the output time interval after the end of the input time interval, based on the membrane potential. The learning device 50 performs learning of a weight coefficient for spike signals.

As a result, it is possible to adjust the weight coefficient through learning, and improve the accuracy of estimation performed by the neural network device 10.

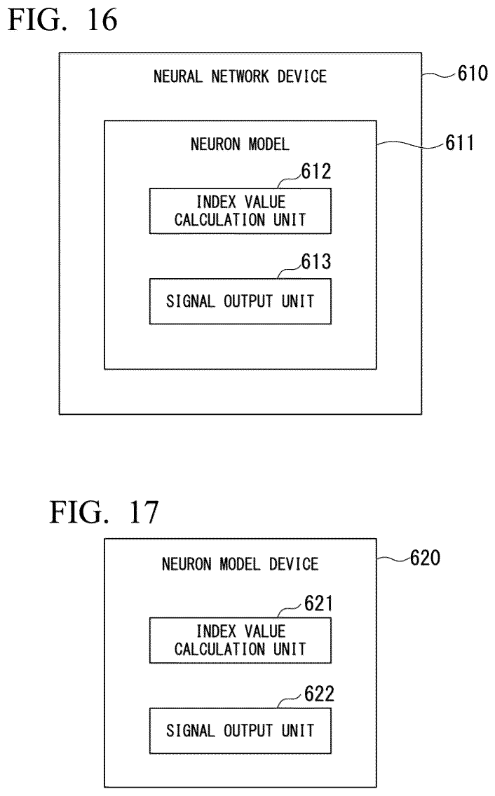

FIG. 16 is a diagram showing a configuration example of the neural network device according to the example embodiment. With the configuration shown in FIG. 11, a neural network device 610 includes a neuron model 611. The neuron model 611 includes an index value calculation unit 612 and a signal output unit 613.

With this configuration, the neuron model 611 is formed to be able to transmit spikes by firing within a certain time interval. In the neural network device 610, input time intervals for receiving spikes and output time intervals in which spike transmission is permitted are divided, in association with firing of the neuron model 611.

For example, the index value calculation unit 612 changes the index value of a signal output, based on the signal input status within the input time interval. The signal output unit 613 outputs a signal within the output time interval after the end of the input time interval by firing based on the index value.

The index value calculation unit 612 corresponds to an example of the index value calculation means. The signal output unit 613 corresponds to an example of the signal output means.

In this way, by setting the input time interval in which the neuron model 611 receives input of signals and the output time interval in which the neuron model 611 outputs spike signals and by firing within the output time interval, it is possible to restrict the time during which the index value calculation unit 612 calculates the index value to the time from the start of the input time interval to the end of the output time interval. At other times, the neuron model 611 may perform processing on other data.

According to the neural network device 610, the spiking neural network is able to process data efficiently in this respect.

Note that as long as signal input and signal output do not interfere with each other in the layer, the input time interval and the output time interval may be defined to overlap therein. For example, the output layer 23 described above is an example of a layer in which signal input and signal output do not interfere with each other. The neuron model 611 applied to such an output layer 23 may have an input/output time interval set in which receiving and transmitting signals are permitted in association with firing. An input/output time interval in which receiving and transmitting signals are permitted may be set instead of the input time interval in which signal output is restricted.

FIG. 17 is a diagram showing a configuration example of a neuron model device according to the example embodiment. In the configuration shown in FIG. 17, a neuron model 620 includes an index value calculation unit 621 and a signal output unit 622.

With such a configuration, input time intervals for receiving signals and output time intervals in which signal transmission is permitted are divided, in association with firing of the neuron model 620. The index value calculation unit 621 changes the index value of a signal output, based on the signal input status within the input time interval. The signal output unit 622 outputs a signal within the output time interval after the end of the input time interval by firing based on the index value.

The index value calculation unit 621 corresponds to an example of the index value calculation means. The signal output unit 622 corresponds to an example of the signal output means.

In this way, by setting the input time interval in which the neuron model device 620 receives input of signals and the output time interval in which the neuron model device 620 outputs spike signals, it is possible to restrict the time during which the index value calculation unit 621 calculates the index value to the time from the start of the input time interval to the end of the output time interval. At other times, the neuron model device 620 may perform processing on other data.

According to the neuron model device 620, the spiking neural network is able to process data efficiently in this respect.

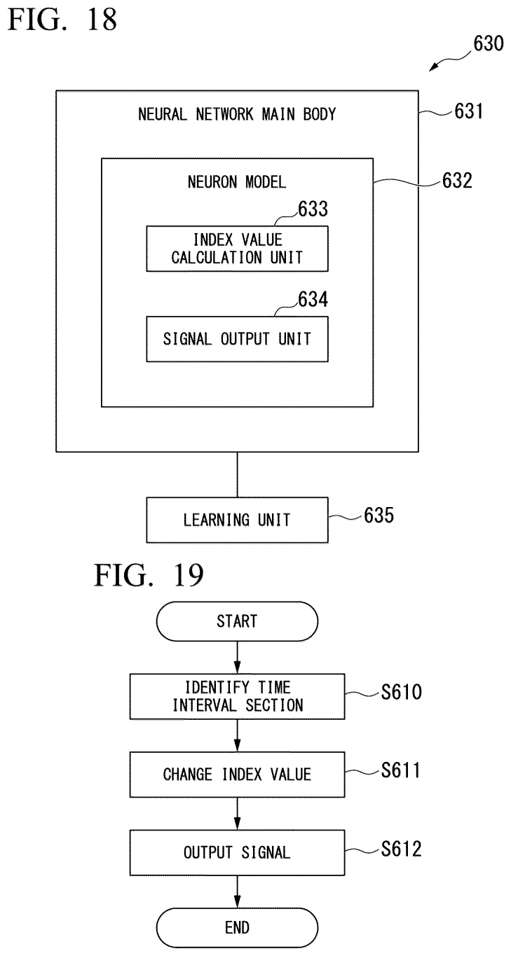

FIG. 18 is a diagram showing a configuration example of a neural network system according to the example embodiment.

With the configuration shown in FIG. 18, a neural network system 630 includes a neural network main body 631 and a learning unit 635. The neural network main body 631 includes a neuron model 632. The neuron model 632 includes an index value calculation unit 633 and a signal output unit 634.

With such a configuration, in the neural network system 630, input time intervals for receiving signals and output time intervals in which signal transmission is permitted are divided, in association with firing of the neuron model device 632. The index value calculation unit 633 changes the index value of a signal output, based on the signal input status within the input time interval. The signal output unit 634 outputs a signal within the output time interval after the end of the input time interval, based on the index value. The learning unit 635 performs learning of a weight coefficient for signals input to the neuron model 632.

The index value calculation unit 633 corresponds to an example of the index value calculation means. The signal output unit 634 corresponds to an example of the signal output means. The learning unit 635 corresponds to an example of the learning means. Performs number learning.

In the neural network system 630, it is thereby possible to adjust the weight coefficient through learning, and improve the accuracy of estimation performed by the neural network main body 631.

FIG. 19 is a flowchart showing an example of a processing procedure in a computing method according to the example embodiment. The computing method shown in FIG. 19 includes: identifying time interval division (Step S610); calculating an index value (Step S611); and outputting a signal (Step S612).

In the step of identifying time interval division (Step S610), input time intervals in which spikes are received and output time intervals in which spikes are allowed to be transmitted are identified. For example, identifying time interval division may include setting a flag according to the identification result. In the step of calculating an index value (Step S611), if the identification result indicates an input time interval, signal input is permitted, and the index value of signal output is changed based on the signal input status in the input time interval. For example, a transition from an input time interval to an output time interval is detected based on the identification result, and the step of outputting a signal (Step S612) is performed in response to this detection. In the step of outputting a signal (Step S612), depending on the identification result (value of the flag), a signal is output within the output time interval after the end of the input time interval by firing based on the index value.

In the computing method shown in FIG. 19, by setting input time intervals for receiving signal input and output time intervals for signal output, and by firing within the output time interval, it is possible to restrict the time at which the index value should be calculated to the time from the start of the input time interval to the end of the output time interval. At other times, processing can be performed on other data.

According to the computing method shown in FIG. 19, the spiking neural network is able to process data efficiently in this respect.

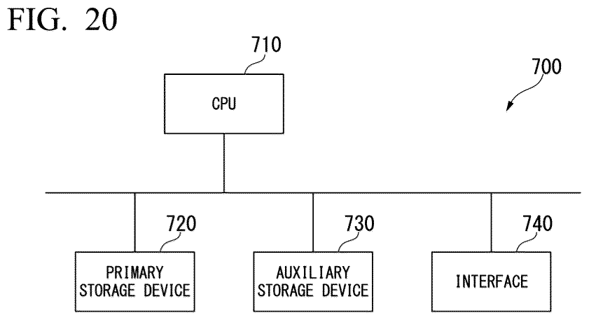

FIG. 20 is a schematic block diagram showing a configuration of a computer according to at least one of the example embodiments.

In the configuration shown in FIG. 20, a computer 700 includes a CPU 710, a primary storage device 720, an auxiliary storage device 730, an interface 740, and a non-volatile recording medium 750.

Any one or more of the neural network device 10, the learning device 50, the neural network device 610, the neuron model device 620, and the neural network system 630 described above, or a portion thereof, may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 reserves, according to the program, storage regions corresponding to the respective storage units mentioned above, in the primary storage device 720. Communication between each device and other devices is executed by the interface 740 having a communication function and communicating under the control of the CPU 710.

In the case where the neural network device 10 is implemented in the computer 700, operations of the neural network device 10 and each component thereof are stored in the form of a program in the auxiliary storage device 730. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the neural network device 10 according to the program. Communication with another device performed by the neural network device 10 is executed by the interface 740 having a communication function and operating under the control of the CPU 710. Interaction between the neural network device 10 and a user is executed by the interface 740 having a display device and an input device, displaying various images under control of the CPU 710, and receiving user operations.

In the case where the learning device 50 is implemented in the computer 700, operations of the learning device 50 are stored in the auxiliary storage device 730 in the form of a program. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the learning device 50, according to the program. Communication with another device performed by the learning device 50 is executed by the interface 740 having a communication function and operating under the control of the CPU 710. Interaction between the learning device 50 and a user is executed by the interface 740 having a display device and an input device, displaying various images under control of the CPU 710, and receiving user operations.

In the case where the neural network device 610 is implemented in the computer 700, operations of the neural network device 610 and each component thereof are stored in the form of a program in the auxiliary storage device 730. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the neural network device 610 according to the program. Communication with another device performed by the neural network device 610 is executed by the interface 740 having a communication function and operating under the control of the CPU 710. Interaction between the neural network device 610 and a user is executed by the interface 740 having a display device and an input device, displaying various images under control of the CPU 710, and receiving user operations.

In the case where the neuron model device 620 is implemented in the computer 700, operations of the neuron model device 620 and each unit thereof are stored in the auxiliary storage device 730 in a form of program. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the neuron model device 620, according to the program. Communication with another device performed by the neuron model device 620 is executed by the interface 740 having a communication function and operating under the control of the CPU 710. Interaction between the neuron model device 620 and a user is executed by the interface 740 having a display device and an input device, displaying various images under control of the CPU 710, and receiving user operations.

In the case where the neural network system 630 is implemented in the computer 700, operations of the neural network system 630 and each component thereof are stored in the form of a program in the auxiliary storage device 730. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the neural network system 630 according to the program. Communication with another device performed by the neural network system 630 is executed by the interface 740 having a communication function and operating under the control of the CPU 710. Interaction between the neural network system 630 and a user is executed by the interface 740 having a display device and an input device, displaying various images under control of the CPU 710, and receiving user operations.

It should be noted that a program for executing some or all of the processes performed by the neural network device 10, the learning device 50, the neural network device 610, the neuron model device 620, and the neural network system 630 may be recorded on a computer-readable recording medium, and the program recorded on the recording medium may be read into and executed on a computer system, to thereby perform the processing of each unit. The “computer system” referred to here includes an operating system and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present invention have been described in detail with reference to the drawings. However, the specific configuration of the invention is not limited to the example embodiments, and may include designs and so forth that do not depart from the scope of the present invention.

### Description of Reference Symbols

1, 630 Neural network system
10, 10A, 610 Neural network device
11, 11A Neural network
21 Input layer
22 Intermediate layer
23 Output layer
24 Feature extraction layer
50 Learning device
100, 611, 632 Neuron model
110, 612, 621, 633 Index value calculation unit
120 Comparison unit
130, 613, 622, 634 Signal output unit
620 Neuron model device
631 Neural network main body
635 Learning unit

What is claimed is:

1. A computing device comprising:
a neuron model in which an input time interval for receiving a spike and an output time interval for firing and a transmitting spike are divided, wherein the neuron model fires within the output time interval, with firing within the input time interval being restricted.

2. The computing device according to claim 1, wherein a firing time at which the neuron model fires within the output time interval is a function of membrane potential of the neuron model at a last time of the input time interval.

3. The computing device according to claim 2, wherein
the neuron model restricts firing in a case where the membrane potential of the neuron model at the last time of the input time interval is outside a predetermined range.

4. The computing device according to claim 1, wherein
the neuron model is formed such that the membrane potential of the neuron model within the output time interval increases with a slope unique to each neuron model.

5. The computing device according to claim 4, wherein
the neuron model is formed to forcibly fire in a case where the membrane potential of the neuron model satisfies a predetermined condition at a posterior edge of the output time interval, or not to fire in the same case.

6. The computing device according to claim 4, wherein
the neuron model starts transmitting the spike in a form of a rectangular waveform in a case where the membrane potential of the neuron model satisfies a predetermined condition within the output time interval, and stops transmitting the spike at a time when the output time interval ends.

7. (canceled)

8. A neuron model device, wherein an input time interval for receiving a spike and an output time interval in which spike transmission is permitted are divided in association with forcible firing, the neuron model device comprising:
a memory configured to store instructions; and
a processor configured to execute the instructions to:
changing an index value of signal output based on an input status of a signal within the input time interval; and
transmitting a spike within the output time interval by firing based on the index value of the signal output.

9. A computing method comprising:
identifying an input time interval for receiving a spike and an output time interval in which spike transmission is permitted that are divided in association with forcible firing;
changing an index value of signal output based on an input status of a signal within the input time interval; and
transmitting a spike within the output time interval by firing based on the index value of the signal output.

10. (canceled)
